(19) United States
(12) Patent Application Publication
(10) Pub. No.: US 2007/0137913 A1
(43) Pub. Date: Jun. 21, 2007

(54) Active chassis for a motor vehicle

(75) Inventors: Uwe Wohanka, Uhldingen-Muhlhofen (DE); Andreas Thies, Friedrichshafen (DE); Wolfgang Kinzelmann, Ravensburg (DE); Heinz Knecht, Eltorf (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/636,099

(22) Filed: Dec. 8, 2006

(30) Foreign Application Priority Data
Dec. 10, 2005 (DE) 102005059116.7

(51) Int. Cl. B60K 28/16

(52) U.S. Cl. 180/197

(57) ABSTRACT

An active chassis for a motor vehicle is proposed that comprises an actuator (2) with a hydraulic or pneumatic positioning cylinder (3) and a vibration absorber (4), wherein the actuator (2) features a partial load-bearing mounting spring (5), where a partial load-bearing second mounting spring (1) is connected in parallel to the actuator (2), the vibration absorber (4) is connected in parallel to the mounting spring (5) of the actuator (2) and the adjusting cylinder (3) is connected in series to the mounting spring (5) and to the vibration absorber (4).

This application claims priority from German Application Serial No. 10 2005 059 116.7 filed Dec. 10, 2005.

### FIELD OF THE INVENTION

The present invention concerns an active chassis for a motor vehicle.

### BACKGROUND OF THE INVENTION

The design of a conventional chassis for a motor vehicle represents a compromise between driving safety and driving comfort, since hard damping ensures good handling and soft damping increasing comfort. In order to be able to combine both aspects, active chassis for compensating rolling, pitching and heaving are known from the prior art.

DE 196 06 991 describes a spring-shock absorber device for a motor vehicle, wherein the distance of the vehicle body in relation to the wheels can be controlled via a hydraulic unit according to vehicle handling, where the spring is stretched between a movable element of the hydraulic unit and the damping cylinder of the shock absorber and where the movable element of the hydraulic unit is slidingly mounted on the shock absorber in such a way that the displacement occurs exclusively in the area of the piston rod of the shock absorber, whereby the frictional forces occurring during the displacement of moveable elements is significantly reduced.

Furthermore, DE 196 04 558 C1 describes a piston-cylinder unit comprising a cylinder in which a piston rod is arranged so that it is axially movable, a first connecting element functionally connected to the cylinder, a second connecting element that is connected to the piston rod, an adjustment cylinder with a pressure medium connection, whereby the adjustment cylinder is operatively connected to one of the connecting elements and where the distance between the first and the second connecting element can be adjusted through the inflow or outflow of pressure medium. Here the adjustment cylinder is arranged in series with the cylinder, while the piston rod constitutes a guideway for the adjustment cylinder.

DE 195 29 580 A1 describes an adjustable suspension strut for motor vehicles that facilitates good position control of the cushioned motor vehicle components and should feature a defined controllable and tunable damping and spring rate. The suspension strut comprises a vibration absorber surrounded by a coil spring and containing a damping cylinder, where the coil spring is held and stretched at one end by a first spring cap connected to the damping cylinder via an outer and an inner positioning cylinder concentrically surrounding the damping cylinder and, at the other end, by a second spring cap connected to the piston rod near the linkage point of the piston rod of the damper piston of the damping cylinder in such a way that stress is placed on the coil spring when the piston is driven into the damping cylinder. In this example, the two positioning cylinders for changing the ground clearance of the automotive body are designed as telescopically displaceable to one another.

In the construction described in DE 195 29 580 A1, the first spring cap is secured to the outer positioning cylinder, where the outer positioning cylinder features at its end facing the piston rod devices for guiding and sealing the damping cylinder, while the opposite end features devices for guiding and sealing the inner positioning cylinder. The inner positioning cylinder is hereby secured to the damping cylinder and can be telescopically displaced relative to the outer positioning cylinder when a pressure medium is introduced into the ring-shaped inner chamber bordered by the positioning cylinder and the damping cylinder.

DE 100 43 711 A1 describes an actuator for active chassis control using a torque-generating actuating element, which is connected to a suspension link secured to the wheel and vehicle body, where the actuating element is arranged between vehicle body and suspension link and where a torque corresponding to the roll and pitch compensation and/or ensuring the damping of the suspension link oscillations is transferred to the suspension link. The actuating element is preferably realized as a swivel motor.

An additional actuator for active chassis control is known from DE 103 06 228 A1. It comprises an actuating element arranged between the wheel and the vehicle body that counters pitching and rolling and also decreases the heaving of the vehicle on the basis of the sky hook principle. The actuating element is realized as a pivoting motor and provides between the wheel and vehicle body an actuator moment for decreasing the heaving of the vehicle body in addition to the actuator moment for compensating roll and pitch.

With these constructions known from the state of the art, the energy requirement is disadvantageously high because of the low end adjustment of the suspension system or activation of the actuator.

DE 44 28 605 A1 describes a hydraulic system for an active chassis, in particular one for compensating roll and pitch, comprising actuators each featuring a pressure accumulator for a front axle and a rear axle of a motor vehicle, a pump for supplying the actuator, inflow and outflow lines from the actuators to a tank, control valves for controlling the actuators and an auxiliary pressure accumulator for each vehicle axle. In this case, the auxiliary pressure accumulator is simultaneously connected to the actuators of a vehicle axle when the vehicle body is essentially horizontal while, when driving around curves, it is shut off from the actuator on the outside of the curvature and connected to an actuator on the inside of the curvature. Furthermore, an adjustable damping device is functionally assigned to the actuators, where the adjustable damping device for the actuator on the inside of the curvature is set for a stronger damping to the degree the actuator on the outside of the curvature is connected to the auxiliary pressure accumulator.

The present invention is based upon the object of providing an active chassis for active chassis control for influencing pitching, heaving and rolling that features the function of automatic leveling and has an energy requirement less than that of the systems of the prior art. Additionally, the actuator of the inventive chassis should be able to be retrofitted into motor vehicles.

### SUMMARY OF THE INVENTION

Accordingly, an active chassis of a motor vehicle is proposed that features an actuator with a hydraulic or pneumatic positioning cylinder, a partial load-bearing mounting spring and a vibration absorber as well as a partial load-bearing second mounting spring connected in parallel with the actuator. Here the vibration absorber is connected in parallel with the actuator, while the positioning cylinder is connected in series with the mounting spring and the vibration absorber.

According to the invention, the static vehicle body masses are borne mostly by the second mounting spring connected in parallel with the actuator. In an advantageous manner, this mounting spring is designed so that it supports the static vertical forces resulting from the current vehicle body mass plus vehicle load. In all other cases, the actuator detects changes in static vehicle body forces through changes in load.

Here the second mounting spring can be an air spring or hydropneumatic suspension, steel spring or steel spring with low end adjustment. For vehicles with low bearing spread, a conventional steel spring is sufficient as second spring where, in this case, the actuator additionally takes over the automatic leveling function. For large bearing spreads, as is the case in utility vehicles for example, the mounting spring is an air spring or hydropneumatic spring and additionally provides automatic leveling, whereby the stationary offset (base load) of the actuator is set to zero so that energy is needed only for the compensation of heaving and/or pitching and/or rolling. The design of the actuator has the advantage that the available suspension travel distances are not a function of load.

The actuator essentially functions to compensate reaction forces from vehicle dynamic changes in the state of the vehicle by applying additional tensile and compressive forces where, owing to the design as a partial load-bearing system and thereby owing to the lower actuator forces, the energy requirement is lower than that of an ABC-system.

Through the inventive design, the stabilizer and the mounting spring of a conventional axle system are substituted in an advantageous manner, resulting in installation space advantages in the area of wheel suspension due to the fact that a hydraulic actuator of full load-bearing design is of only slightly larger construction than a conventional damper. The required ancillary components of the actuator are advantageously mounted on the automotive body.

An additional advantage is found in the fact that the actuator of the inventive active chassis can be integrated retroactively or optionally into an existing system as an add-on solution at relatively low cost. Furthermore, the actuator can be scaled within a wide range and can be employed in subcompacts as well as in conventional heavy trucks and busses.

### BRIEF DESCRIPTION OF THE DRAWINGS

The invention will now be described, by way of example, with reference to the accompanying drawings in which:

FIG. 1 is a schematic representation of an inventive active chassis;

FIG. 2 is a schematic representation of the setup for controlling a hydraulic positioning cylinder of the actuator for an active chassis according to the invention;

FIG. 3 is a schematic representation of a further embodiment of the setup for controlling a hydraulic positioning cylinder of the actuator for an active chassis according to the invention, and

FIG. 4 is a schematic representation of a further embodiment of the setup for controlling a hydraulic positioning cylinder of the actuator for an active chassis according to the invention.

### DETAILED DESCRIPTION OF THE INVENTION

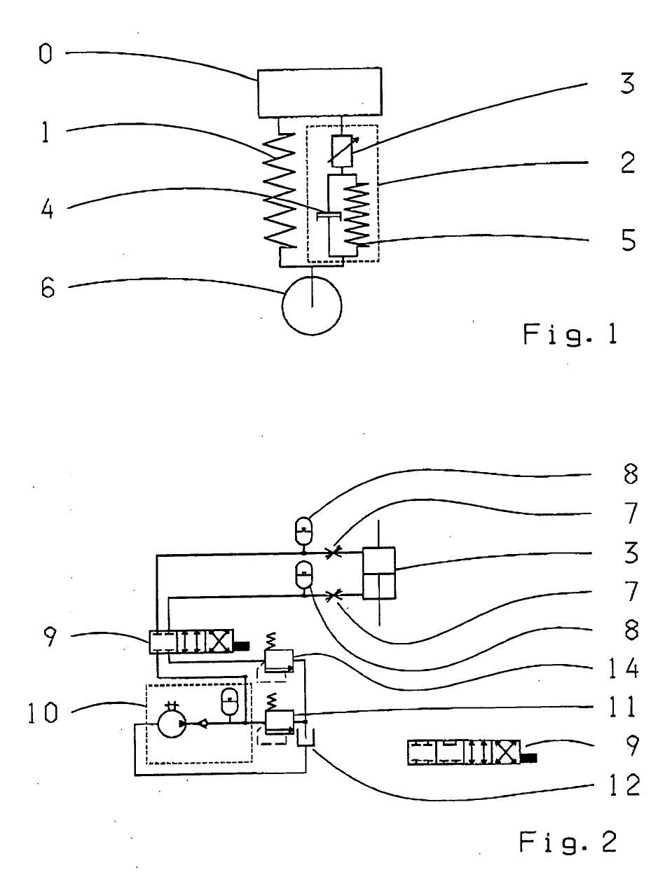

As FIG. 1 illustrates, an inventive active chassis comprises an actuator 2, which features a hydraulic positioning cylinder 3, a vibration absorber 4 and a partial load-bearing mounting spring 5, where a partial load-bearing second mounting spring 1 is connected in parallel with the actuator 2; the vehicle body mass is labeled 0 and the unsprung wheel mass is labeled 6. Here the vibration absorber 4 is connected in parallel with the mounting spring 5; the positioning cylinder 3 is connected in series with the mounting spring 5 and the vibration absorber 4. Although the invention is explained using an embodiment that features a hydraulic positioning cylinder, the positioning cylinder can also be realized as pneumatic.

FIG. 2 illustrates a possible embodiment of the setup for controlling the hydraulic positioning cylinder 3 of the actuator 2 for an active chassis as claimed in the invention. A control valve 9 is provided, where the required tensile-/compressive force in the piston rod of the positioning cylinder 3 is generated by the pressure differential of the two working chambers of the hydraulic positioning cylinder 3. The pressure decrease is determined by the flow resistance of the tank vent line and by a pressure valve 14 for adjusting the minimum pressure of the system.

For the partial load-bearing system as claimed in the invention, the positioning cylinder 3 of the hydraulic actuator 2 is controlled or regulated separately for the piston and rod-side, so that when load is removed from a wheel 6 as the result of dynamic changes in the state of the vehicle, the actuator can act against the energy stored in the mounting spring 1 (compression of the mounting spring 1 upon removal of load) and the wheel 6 does not rebound during static load relieving. If additional load is placed on the wheel, the hydraulic actuator 2 supports the mounting spring 1 and applies additional forces, so that the wheel 6 does not deflect during static loading.

According to the invention, the damping force for the rebound and deflection is adjusted via the two damping valves 7 per positioning cylinder 3 independently of one another, whereby no adjustment of the damping valve for the one movement direction is required, if the movement direction reverses. This results in a more exact and faster adjustment of damping force compared to that of a system featuring a valve for both of the movement directions, which must jump to another position in a disadvantageous manner when a change in movement direction occurs. As FIG. 2 shows, a gas spring 8 is connected in front of each damping valve 7.

According to the invention, dynamic changes in wheel load in the low frequency range (e.g., during normal cornering or sustained acceleration or braking) are compensated through changing the average working pressure in the working chambers of the cylinder 3, where an increase in wheel load results in a pressure increase in the cylinder chamber and/or a pressure decrease in the piston rod chamber, while a decrease in wheel load results in a pressure decrease in the cylinder chamber and/or a pressure increase in the piston rod chamber. In FIG. 2 the hydraulic supply is labeled 10, a pressure valve 11 and a tank for the hydraulic fluid 12.

High frequency changes in wheel load (e.g., during sudden lane change or appearance of pitch oscillation at the start of braking) are partly compensated through the damping valves 7 according to comfort considerations and can, when combined with, for example, CDC-valves or ASD-valves or similar systems, add to gains in driving safety and comfort.

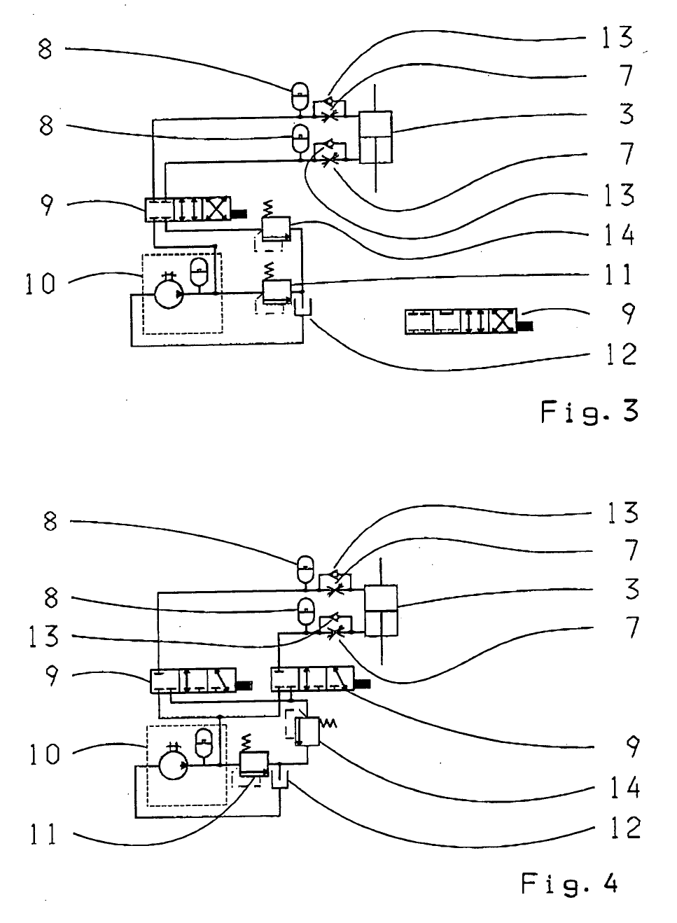

The arrangement shown in FIG. 3 is distinguished from the setup shown in FIG. 2 in that a check valve 13 is connected in parallel with each damping valve 7. As in the example shown in FIG. 1, one control valve 9 per wheel is necessary.

The embodiment shown in FIG. 4 is distinguished from that of FIG. 3 in that two control valves 9 are provided per wheel, where each control valve 9 is connected to the damping valve 7.

The present invention provides an active chassis that allows the functions of compensation of heaving and/or pitching- and/or rolling- and/or automatic leveling to be integrated in one actuator system per wheel and replaces a conventional or passive stabilizer. Furthermore, the actuator can be integrated into any motor vehicle (e.g., single or double track vehicles with any number of axles).

In designing the hydraulic actuator to a pressure level of approximately 150 bar to 180 bar, the construction space of the conventional damper can be used. Furthermore, the actuator can be retrofitted into a motor vehicle in an advantageous manner and can be combined with all existing systems of dampers (passive damping, CDC, ASD, sky hook principles).

The actuator of the active chassis can be installed as an option or retrofitted into a vehicle. A retrofit on a purely passive system is also conceivable.

Of course, each design-related development, in particular, each spatial arrangement of the components—both inherently and in relation to one another and to the extent technically sensible—of the inventive active chassis or of the actuator for an active chassis as well as of the setup for controlling the positioning cylinder, falls under the scope of protection of the present claims without influencing the function of the active chassis or the actuator as it is stated in the claims, even if these developments are not explicitly represented in the Figures or in the description.

### REFERENCE NUMERALS

0 vehicle body mass
1 partial load-bearing mounting spring
2 actuator
3 hydraulic positioning cylinder
4 vibration absorber
5 partial load-bearing mounting spring
6 unsprung wheel masses
7 damping valve
8 gas spring
9 control valve
10 hydraulic supply
11 pressure valve
12 tank
13 check valve
14 pressure valve

1-10. (canceled)

11. An active chassis for a motor vehicle comprising an actuator with one of a hydraulic and a pneumatic positioning cylinder and a vibration absorber, the actuator (2) having a first partial load-bearing mounting spring (5) and a second partial load-bearing mounting spring (1) is connected in parallel with the actuator (2), the vibration absorber (4) is connected in parallel with the first mounting spring (5) of the actuator (2) and the positioning cylinder (3) is connected in series with the first mounting spring (5) and the vibration absorber (4).

12. The active chassis for a motor vehicle according to claim 11, wherein a static vehicle body mass (0) is substantially borne by the second mounting spring (1) connected in parallel with the actuator (2), and the mounting spring (1) supports static vertical forces which result from a current vehicle body mass plus a vehicle load such that the actuator (2) detects changes in static vehicle body forces through changes in load.

13. The active chassis for a motor vehicle according to claim 11, wherein a conventional steel spring is sufficient as the second mounting spring (1) for vehicles with a low bearing spread, and the actuator (2) additionally takes over automatic leveling.

14. The active chassis for a motor vehicle according to claim 11, wherein the second mounting spring (1) is one of an air spring and a hydropneumatic spring for a vehicle with a large bearing spread and additionally provides automatic leveling, and a stationary offset (base load) of the actuator (2) is set to zero.

15. The active chassis for a motor vehicle according to claim 11, wherein two damping valves (7) communicate with each positioning cylinder (3) such that a damping force for closing and opening spring motion can be adjusted via the two damping valves (7) independently of one another, and a gas spring (8) is connected in front of the two damping valves (7).

16. The active chassis for a motor vehicle according to claim 11, wherein dynamic changes in wheel load in a low frequency range is compensated by changing an average working pressure in working chambers of the positioning cylinder (3), where one or more of an increase in wheel load results in a pressure increase in a cylinder chamber and a pressure decrease in the piston rod chamber, while a decrease in wheel load results in one or more of a pressure decrease in the cylinder chamber and a pressure increase in the piston rod chamber and where high frequency changes in wheel load can be partly compensated through the damping valves (7) according to comfort considerations.

17. The active chassis for a motor vehicle according to claim 11, wherein the positioning cylinder (3) of the hydraulic actuator (2) can be one of controlled and regulated separately for a piston and rod-side such that when a load is removed from a wheel (6), as a result of dynamic changes in a state of the vehicle, the actuator (2) can act against energy stored in the first mounting spring (1) such that the wheel (6) does not rebound during static load relieving and where, if an additional load is placed on the wheel (6), the actuator (2) supports the mounting spring (1) and applies additional forces, such that the wheel (6) does not deflect during static loading.

18. The active chassis for a motor vehicle according to claim 11, wherein a check valve (13) is connected parallel to each damping valve (7).

19. The active chassis for a motor vehicle according to claim 11, wherein one control valve (9) is provided per wheel.

20. The active chassis for a motor vehicle according to claim 11, wherein two control valves (9) are provided per wheel.
